(19) United States
(12) Patent Application Publication
(10) Pub. No.: US 2016/0026857 A1
(43) Pub. Date: Jan. 28, 2016

(54) IMAGE PROCESSOR COMPRISING GESTURE RECOGNITION SYSTEM WITH STATIC HAND POSE RECOGNITION BASED ON DYNAMIC WARPING

(71) Applicant: LSI Corporation, San Jose, CA (US)

(72) Inventors: Alexander A. Petyushko, Moscow (RU); Ivan L. Mazurenko, Moscow (RU); Dmitry N. Babin, Moscow (RU); Aleksey A. Letunovskiy, Moscow (RU); Alexander B. Kholodenko, Moscow (RU)

(21) Appl. No.: 14/374,392

(22) PCT Filed: Jul. 23, 2014
(86) PCT No.: PCT/US14/47744

§ 371 Date: Jul. 24, 2014

(51) Int. Cl. G06K 9/00; G06T 7/00; G06K 9/48; G06F 3/01; G06K 9/46

(52) U.S. Cl. CPC G06K 9/00355; G06F 3/017; G06K 9/4604; G06K 9/481; G06T 7/0079; G06K 9/00744

(57) ABSTRACT

An image processing system comprises an image processor having image processing circuitry and an associated memory. The image processor is configured to implement a gesture recognition system comprising a static pose recognition module. The static pose recognition module is configured to identify a hand region of interest in at least one image, to extract a contour of the hand region of interest, to compute a feature vector based at least in part on the extracted contour, and to recognize a static pose of the hand region of interest utilizing a dynamic warping operation based at least in part on the feature vector.

### FIELD

The field relates generally to image processing, and more particularly to image processing for recognition of gestures.

### BACKGROUND

Image processing is important in a wide variety of different applications, and such processing may involve two-dimensional (2D) images, three-dimensional (3D) images, or combinations of multiple images of different types. For example, a 3D image of a spatial scene may be generated in an image processor using triangulation based on multiple 2D images captured by respective cameras arranged such that each camera has a different view of the scene. Alternatively, a 3D image can be generated directly using a depth imager such as a structured light (SL) camera or a time of flight (ToF) camera. These and other 3D images, which are also referred to herein as depth images, are commonly utilized in machine vision applications, including those involving gesture recognition.

In a typical gesture recognition arrangement, raw image data from an image sensor is usually subject to various preprocessing operations. The preprocessed image data is then subject to additional processing used to recognize gestures in the context of particular gesture recognition applications. Such applications may be implemented, for example, in video gaming systems, kiosks or other systems providing a gesture-based user interface. These other systems include various electronic consumer devices such as laptop computers, tablet computers, desktop computers, mobile phones and television sets.

### SUMMARY

In one embodiment, an image processing system comprises an image processor having image processing circuitry and an associated memory. The image processor is configured to implement a gesture recognition system comprising a static pose recognition module. The static pose recognition module is configured to identify a hand region of interest in at least one image, to extract a contour of the hand region of interest, to compute a feature vector based at least in part on the extracted contour, and to recognize a static pose of the hand region of interest utilizing a dynamic warping operation based at least in part on the feature vector.

Other embodiments of the invention include but are not limited to methods, apparatus, systems, processing devices, integrated circuits, and computer-readable storage media having computer program code embodied therein.

### BRIEF DESCRIPTION OF THE DRAWINGS

FIG. 1 is a block diagram of an image processing system comprising an image processor implementing a static pose recognition module in an illustrative embodiment.

FIG. 2 is a flow diagram of an exemplary static pose recognition process performed by the static pose recognition module in the image processor of FIG. 1.

FIG. 3 shows an example of an extracted contour comprising an ordered list of points.

FIGS. 4A and 4B illustrate respective left hand and right hand versions of a given hand region of interest.

FIG. 5 illustrates the generation of a feature vector using an extracted contour.

FIG. 6 is a flow diagram of a process for determining a centroid of a static pose class.

FIG. 7 is a flow diagram of a process for determining pattern statistics for a static pose class using a centroid determined by the process of FIG. 6.

### DETAILED DESCRIPTION

Embodiments of the invention will be illustrated herein in conjunction with exemplary image processing systems that include image processors or other types of processing devices configured to perform gesture recognition. It should be understood, however, that embodiments of the invention are more generally applicable to any image processing system or associated device or technique that involves recognizing static poses in one or more images.

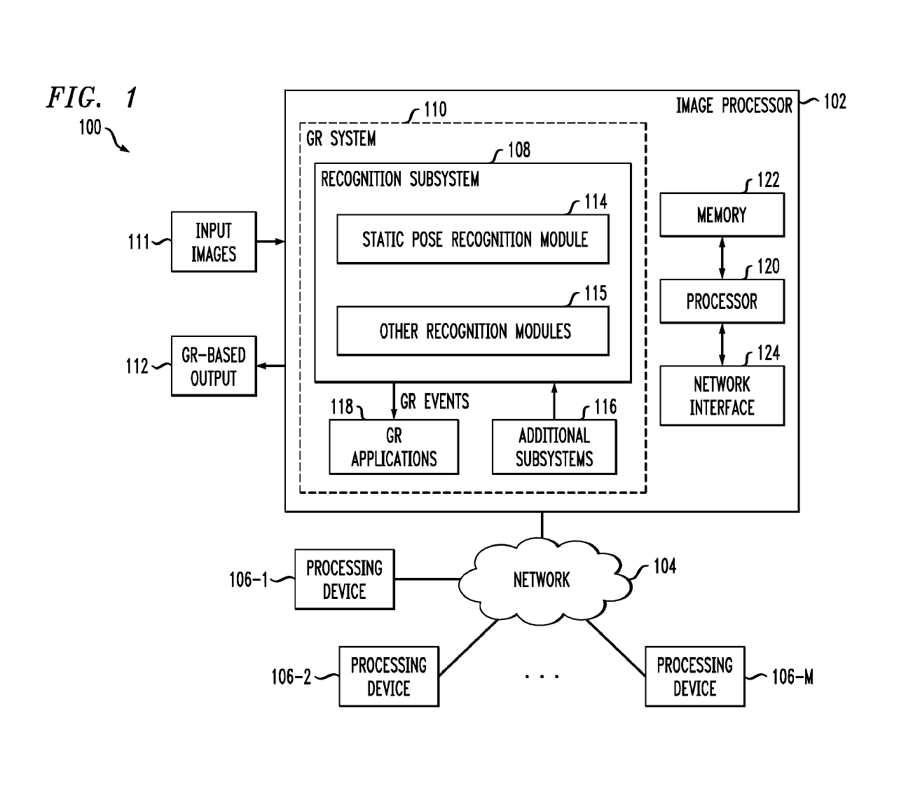

FIG. 1 shows an image processing system 100 in an embodiment of the invention. The image processing system 100 comprises an image processor 102 that is configured for communication over a network 104 with a plurality of processing devices 106-1, 106-2, . . . 106-M. The image processor 102 implements a recognition subsystem 108 within a gesture recognition (GR) system 110. The GR system 110 in this embodiment processes input images 111 from one or more image sources and provides corresponding GR-based output 112. The GR-based output 112 may be supplied to one or more of the processing devices 106 or to other system components not specifically illustrated in this diagram.

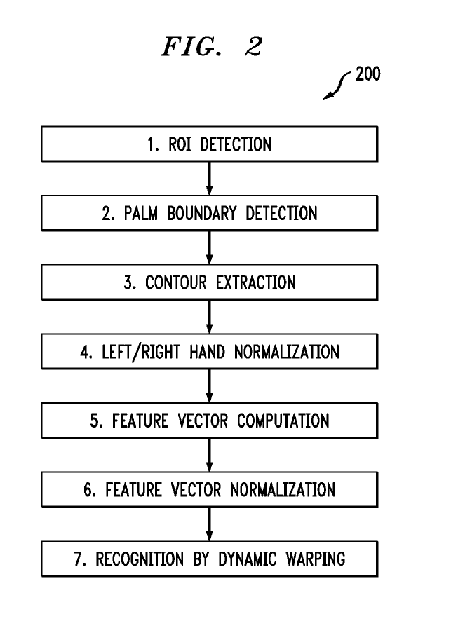

The recognition subsystem 108 of GR system 110 more particularly comprises a static pose recognition module 114 and one or more other recognition modules 115. The other recognition modules may comprise, for example, respective recognition modules configured to recognize cursor gestures and dynamic gestures. The operation of illustrative embodiments of the GR system 110 of image processor 102 will be described in greater detail below in conjunction with FIGS. 2 through 7.

The recognition subsystem 108 receives inputs from additional subsystems 116, which may comprise one or more image processing subsystems configured to implement functional blocks associated with gesture recognition in the GR system 110, such as, for example, functional blocks for input frame acquisition, noise reduction, background estimation and removal, or other types of preprocessing. In some embodiments, the background estimation and removal block is implemented as a separate subsystem that is applied to an input image after a preprocessing block is applied to the image.

Exemplary noise reduction techniques suitable for use in the GR system 110 are described in PCT International Application PCT/US 13/56937, filed on Aug. 28, 2013 and entitled “Image Processor With Edge-Preserving Noise Suppression Functionality,” which is commonly assigned herewith and incorporated by reference herein.

Exemplary background estimation and removal techniques suitable for use in the GR system 110 are described in Russian Patent Application No. 2013135506, filed Jul. 29, 2013 and entitled “Image Processor Configured for Efficient Estimation and Elimination of Background Information in Images,” which is commonly assigned herewith and incorporated by reference herein.

It should be understood, however, that these particular functional blocks are exemplary only, and other embodiments of the invention can be configured using other arrangements of additional or alternative functional blocks.

In the FIG. 1 embodiment, the recognition subsystem 108 generates GR events for consumption by one or more of a set of GR applications 118. For example, the GR events may comprise information indicative of recognition of one or more particular gestures within one or more frames of the input images 111, such that a given GR application in the set of GR applications 118 can translate that information into a particular command or set of commands to be executed by that application. Accordingly, the recognition subsystem 108 recognizes within the image a gesture from a specified gesture vocabulary and generates a corresponding gesture pattern identifier (ID) and possibly additional related parameters for delivery to one or more of the applications 118. The configuration of such information is adapted in accordance with the specific needs of the application.

Additionally or alternatively, the GR system 110 may provide GR events or other information, possibly generated by one or more of the GR applications 118, as GR-based output 112. Such output may be provided to one or more of the processing devices 106. In other embodiments, at least a portion of the set of GR applications 118 is implemented at least in part on one or more of the processing devices 106.

Portions of the GR system 110 may be implemented using separate processing layers of the image processor 102. These processing layers comprise at least a portion of what is more generally referred to herein as “image processing circuitry” of the image processor 102. For example, the image processor 102 may comprise a preprocessing layer implementing a preprocessing module and a plurality of higher processing layers for performing other functions associated with recognition of gestures within frames of an input image stream comprising the input images 111. Such processing layers may also be implemented in the form of respective subsystems of the GR system 110.

It should be noted, however, that embodiments of the invention are not limited to recognition of static or dynamic hand gestures, but can instead be adapted for use in a wide variety of other machine vision applications involving gesture recognition, and may comprise different numbers, types and arrangements of modules, subsystems, processing layers and associated functional blocks.

Also, certain processing operations associated with the image processor 102 in the present embodiment may instead be implemented at least in part on other devices in other embodiments. For example, preprocessing operations may be implemented at least in part in an image source comprising a depth imager or other type of imager that provides at least a portion of the input images 111. It is also possible that one or more of the applications 118 may be implemented on a different processing device than the subsystems 108 and 116, such as one of the processing devices 106.

Moreover, it is to be appreciated that the image processor 102 may itself comprise multiple distinct processing devices, such that different portions of the GR system 110 are implemented using two or more processing devices. The term “image processor” as used herein is intended to be broadly construed so as to encompass these and other arrangements.

The GR system 110 performs preprocessing operations on received input images 111 from one or more image sources. This received image data in the present embodiment is assumed to comprise raw image data received from a depth sensor, but other types of received image data may be processed in other embodiments. Such preprocessing operations may include noise reduction and background removal.

The raw image data received by the GR system 110 from the depth sensor may include a stream of frames comprising respective depth images, with each such depth image comprising a plurality of depth image pixels. For example, a given depth image D may be provided to the GR system 110 in the form of a matrix of real values. A given such depth image is also referred to herein as a depth map.

A wide variety of other types of images or combinations of multiple images may be used in other embodiments. It should therefore be understood that the term “image” as used herein is intended to be broadly construed.

The image processor 102 may interface with a variety of different image sources and image destinations. For example, the image processor 102 may receive input images 111 from one or more image sources and provide processed images as part of GR-based output 112 to one or more image destinations. At least a subset of such image sources and image destinations may be implemented as least in part utilizing one or more of the processing devices 106.

Accordingly, at least a subset of the input images 111 may be provided to the image processor 102 over network 104 for processing from one or more of the processing devices 106. Similarly, processed images or other related GR-based output 112 may be delivered by the image processor 102 over network 104 to one or more of the processing devices 106. Such processing devices may therefore be viewed as examples of image sources or image destinations as those terms are used herein.

A given image source may comprise, for example, a 3D imager such as an SL camera or a ToF camera configured to generate depth images, or a 2D imager configured to generate grayscale images, color images, infrared images or other types of 2D images. It is also possible that a single imager or other image source can provide both a depth image and a corresponding 2D image such as a grayscale image, a color image or an infrared image. For example, certain types of existing 3D cameras are able to produce a depth map of a given scene as well as a 2D image of the same scene. Alternatively, a 3D imager providing a depth map of a given scene can be arranged in proximity to a separate high-resolution video camera or other 2D imager providing a 2D image of substantially the same scene.

Another example of an image source is a storage device or server that provides images to the image processor 102 for processing.

A given image destination may comprise, for example, one or more display screens of a human-machine interface of a computer or mobile phone, or at least one storage device or server that receives processed images from the image processor 102.

It should also be noted that the image processor 102 may be at least partially combined with at least a subset of the one or more image sources and the one or more image destinations on a common processing device. Thus, for example, a given image source and the image processor 102 may be collectively implemented on the same processing device. Similarly, a given image destination and the image processor 102 may be collectively implemented on the same processing device.

In the present embodiment, the image processor 102 is configured to recognize hand gestures, although the disclosed techniques can be adapted in a straightforward manner for use with other types of gesture recognition processes.

As noted above, the input images 111 may comprise respective depth images generated by a depth imager such as an SL camera or a ToF camera. Other types and arrangements of images may be received, processed and generated in other embodiments, including 2D images or combinations of 2D and 3D images.

The particular arrangement of subsystems, applications and other components shown in image processor 102 in the FIG. 1 embodiment can be varied in other embodiments. For example, an otherwise conventional image processing integrated circuit or other type of image processing circuitry suitably modified to perform processing operations as disclosed herein may be used to implement at least a portion of one or more of the components 114, 115, 116 and 118 of image processor 102. One possible example of image processing circuitry that may be used in one or more embodiments of the invention is an otherwise conventional graphics processor suitably reconfigured to perform functionality associated with one or more of the components 114, 115, 116 and 118.

The processing devices 106 may comprise, for example, computers, mobile phones, servers or storage devices, in any combination. One or more such devices also may include, for example, display screens or other user interfaces that are utilized to present images generated by the image processor 102. The processing devices 106 may therefore comprise a wide variety of different destination devices that receive processed image streams or other types of GR-based output 112 from the image processor 102 over the network 104, including by way of example at least one server or storage device that receives one or more processed image streams from the image processor 102.

Although shown as being separate from the processing devices 106 in the present embodiment, the image processor 102 may be at least partially combined with one or more of the processing devices 106. Thus, for example, the image processor 102 may be implemented at least in part using a given one of the processing devices 106. As a more particular example, a computer or mobile phone may be configured to incorporate the image processor 102 and possibly a given image source. Image sources utilized to provide input images 111 in the image processing system 100 may therefore comprise cameras or other imagers associated with a computer, mobile phone or other processing device. As indicated previously, the image processor 102 may be at least partially combined with one or more image sources or image destinations on a common processing device.

The image processor 102 in the present embodiment is assumed to be implemented using at least one processing device and comprises a processor 120 coupled to a memory 122. The processor 120 executes software code stored in the memory 122 in order to control the performance of image processing operations. The image processor 102 also comprises a network interface 124 that supports communication over network 104. The network interface 124 may comprise one or more conventional transceivers. In other embodiments, the image processor 102 need not be configured for communication with other devices over a network, and in such embodiments the network interface 124 may be eliminated.

The processor 120 may comprise, for example, a microprocessor, an application-specific integrated circuit (ASIC), a field-programmable gate array (FPGA), a central processing unit (CPU), an arithmetic logic unit (ALU), a digital signal processor (DSP), or other similar processing device component, as well as other types and arrangements of image processing circuitry, in any combination. A “processor” as the term is generally used herein may therefore comprise portions or combinations of a microprocessor, ASIC, FPGA, CPU, ALU, DSP or other image processing circuitry.

The memory 122 stores software code for execution by the processor 120 in implementing portions of the functionality of image processor 102, such as the subsystems 108 and 116 and the GR applications 118. A given such memory that stores software code for execution by a corresponding processor is an example of what is more generally referred to herein as a computer-readable storage medium having computer program code embodied therein, and may comprise, for example, electronic memory such as random access memory (RAM) or read-only memory (ROM), magnetic memory, optical memory, or other types of storage devices in any combination.

Articles of manufacture comprising such computer-readable storage media are considered embodiments of the invention. The term “article of manufacture” as used herein should be understood to exclude transitory, propagating signals.

It should also be appreciated that embodiments of the invention may be implemented in the form of integrated circuits. In a given such integrated circuit implementation, identical die are typically formed in a repeated pattern on a surface of a semiconductor wafer. Each die includes an image processor or other image processing circuitry as described herein, and may include other structures or circuits. The individual die are cut or diced from the wafer, then packaged as an integrated circuit. One skilled in the art would know how to dice wafers and package die to produce integrated circuits. Integrated circuits so manufactured are considered embodiments of the invention.

The particular configuration of image processing system 100 as shown in FIG. 1 is exemplary only, and the system 100 in other embodiments may include other elements in addition to or in place of those specifically shown, including one or more elements of a type commonly found in a conventional implementation of such a system.

For example, in some embodiments, the image processing system 100 is implemented as a video gaming system or other type of gesture-based system that processes image streams in order to recognize user gestures. The disclosed techniques can be similarly adapted for use in a wide variety of other systems requiring a gesture-based human-machine interface, and can also be applied to other applications, such as machine vision systems in robotics and other industrial applications that utilize gesture recognition.

Also, as indicated above, embodiments of the invention are not limited to use in recognition of hand gestures, but can be applied to other types of gestures as well. The term “gesture” as used herein is therefore intended to be broadly construed.

The operation of the GR system 110 of image processor 102 will now be described in greater detail with reference to the diagrams of FIGS. 2 through 7.

It is assumed in these embodiments that the input images 111 received in the image processor 102 from an image source comprise input depth images each referred to as an input frame. As indicated above, this source may comprise a depth imager such as an SL or ToF camera comprising a depth image sensor. Other types of image sensors including, for example, grayscale image sensors, color image sensors or infrared image sensors, may be used in other embodiments. A given image sensor typically provides image data in the form of one or more rectangular matrices of real or integer numbers corresponding to respective input image pixels. These matrices can contain per-pixel information such as depth values and corresponding amplitude or intensity values. Other per-pixel information such as color, phase and validity may additionally or alternatively be provided.

Referring now to FIG. 2, a process 200 performed by the static pose recognition module 114 in an illustrative embodiment is shown. The process is assumed to be applied to preprocessed image frames received from a preprocessing subsystem of the set of additional subsystems 116. The preprocessing subsystem performs noise reduction and background estimation and removal, using techniques such as those identified above. The image frames are received by the preprocessing system as raw image data from an image sensor of a depth imager such as a ToF camera or other type of ToF imager.

In some embodiments, the image sensor comprises a variable frame rate image sensor, such as a ToF image sensor configured to operate at a variable frame rate. In such an embodiment, the static pose recognition module 114 or at least portions thereof can operate at a lower frame rate than other recognition modules 115, such as recognition modules configured to recognize cursor gestures and dynamic gestures. However, use of variable frame rates is not a requirement, and a wide variety of other types of sources supporting fixed frame rates can be used in implementing a given embodiment.

The process 200 includes the following steps:

1. Region of interest (ROI) detection;

2. Palm boundary detection;

3. Contour extraction;

4. Left/right hand normalization;

5. Feature vector computation;

6. Feature vector normalization; and

7. Recognition by dynamic warping.

Each of the above-listed steps of the process 200 will be described in greater detail below. In other embodiments, certain steps may be combined with one another, or additional or alternative steps may be used.

Step 1. ROI Detection

This step in the present embodiment more particularly involves defining an ROI mask for a hand in the input image. The ROI mask is implemented as a binary mask in the form of an image, also referred to herein as a “hand image,” in which pixels within the ROI are have a certain binary value, illustratively a logic 1 value, and pixels outside the ROI have the complementary binary value, illustratively a logic 0 value. The ROI corresponds to a hand within the input image, and is therefore also referred to herein as a hand ROI.

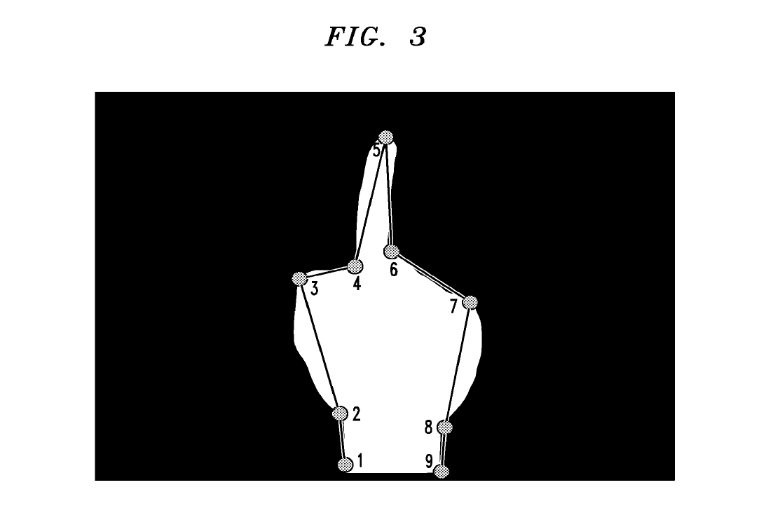

Examples of ROI masks each comprising a hand ROI can be seen in FIGS. 3, 4A, 4B and 5 in the context of various steps of the FIG. 2 process. In a given such exemplary ROI mask, the ROI mask is shown with 1-valued or “white” pixels identifying those pixels within the ROI, and 0-valued or “black” pixels identifying those pixels outside of the ROI.

As noted above, the input image in which the hand ROI is identified in Step 1 may be supplied by a ToF imager. Such a ToF imager typically comprises a light emitting diode (LED) light source that illuminates an imaged scene. Distance is measured based on the time difference between the emission of light onto the scene from the LED source and the receipt at the image sensor of corresponding light reflected back from objects in the scene. Using the speed of light, one can calculate the distance to a given point on an imaged object for a particular pixel as a function of the time difference between emitting the incident light and receiving the reflected light. This distance is more generally referred to herein as a depth value.

The hand ROI can be identified in the preprocessed image using any of a variety of techniques. For example, it is possible to utilize the techniques disclosed in the above-cited Russian Patent Application No. 2013135506 to determine the hand ROI. Accordingly, the first step of the process 200 may be implemented in a preprocessing block of the GR system 110 rather than in the static pose recognition module 114.

As another example, the hand ROI can be determined using threshold logic applied to depth and amplitude values of the image. This can be more particularly implemented as follows:

1. If the amplitude values are known for respective pixels of the image, one can select only those pixels with amplitude values greater than some predefined threshold. This approach is applicable not only for images from ToF imagers, but also for images from other types of imagers, such as infrared imagers with active lighting. For both ToF imagers and infrared imagers with active lighting, the closer an object is to the imager, the higher the amplitude values of the corresponding image pixels, not taking into account reflecting materials. Accordingly, selecting only pixels with relatively high amplitude values allows one to preserve close objects from an imaged scene and to eliminate far objects from the imaged scene. It should be noted that for ToF imagers, pixels with lower amplitude values tend to have higher error in their corresponding depth values, and so removing pixels with low amplitude values additionally protects one from using incorrect depth information.

2. If the depth values are known for respective pixels of the image, one can select only those pixels with depth values falling between predefined minimum and maximum threshold depths Dmin and Dmax. These thresholds are set to appropriate distances between which the hand is expected to be located within the image. For example, the thresholds may be set as Dmin=0, Dmax=0.5 meters (m), although other values can be used.

3. Opening or closing morphological operations utilizing erosion and dilation operators can be applied to remove dots and holes as well as other spatial noise in the image.

One possible implementation of a threshold-based ROI determination technique using both amplitude and depth thresholds is as follows:

1. Set ROIᵢⱼ=0 for each i and j.

2. For each depth pixel dᵢⱼ set ROIᵢⱼ=1 if dᵢⱼ≧dₘᵢₙ and dᵢⱼ≦dₘₐₓ.

3. For each amplitude pixel aᵢⱼ set ROIᵢⱼ=1 if aᵢⱼ≧aₘᵢₙ.

4. Coherently apply an opening morphological operation comprising erosion followed by dilation to both ROI and its complement to remove dots and holes comprising connected regions of ones and zeros having area less than a minimum threshold area Aₘᵢₙ.

The output of the above-described ROI determination process is a binary ROI mask for the hand in the image. It can be in the form of an image having the same size as the input image, or a sub-image containing only those pixels that are part of the ROI. For further description below, it is assumed that the ROI mask is an image having the same size as the input image. As mentioned previously, the ROI mask is also referred to herein as a “hand image” and the ROI itself within the ROI mask is referred to as a “hand ROI.” The output may include additional information such as an average of the depth values for the pixels in the ROI.

Step 2. Palm Boundary Detection

This step in the present embodiment more particularly involves defining the palm boundary and removing from the ROI any pixels below the palm boundary, leaving essentially only the palm and fingers in a modified hand image. Such a step advantageously eliminates, for example, any portions of the arm from the wrist to the elbow, as these portions can be highly variable due to the presence of items such as sleeves, wristwatches and bracelets, and in any event are typically not useful for static hand pose recognition.

Exemplary techniques that are suitable for use in implementing the palm boundary determination in the present embodiment are described in Russian Patent Application No. 2013134325, filed Jul. 22, 2013 and entitled “Gesture Recognition Method and Apparatus Based on Analysis of Multiple Candidate Boundaries,” which is commonly assigned herewith and incorporated by reference herein.

Alternative techniques can be used. For example, the palm boundary may be determined by taking into account that the typical length of the human hand is about 20-25 centimeters (cm), and removing from the ROI all pixels located farther than a 25 cm threshold distance from the uppermost fingertip, possibly along a determined main direction of the hand. The uppermost fingertip can be identified simply as the uppermost 1 value in the binary ROI mask. The 25 cm threshold can be converted to a particular number of image pixels by using an average depth value determined for the pixels in the ROI as mentioned in conjunction with the description of Step 1 above.

Step 3. Contour Extraction

In this step, the contour of the hand ROI is determined, so as to permit the contour to be used in place of the hand ROI in subsequent processing steps. By way of example, the contour is represented as ordered list of points characterizing the general shape of the hand ROI. The use of such a contour in place of the hand ROI itself provides substantially increased processing efficiency in terms of both computational and storage resources.

A more particular example of an extracted contour comprising an ordered list of points selected from the hand ROI is shown in FIG. 3. In this example, the contour of a hand ROI for a pointing finger gesture comprises the ordered list of points denoted 1, 2, 3, 4, 5, 6, 7, 8, 9 in the figure. The contour in this example generally characterizes the border of the hand ROI in a clockwise direction.

More generally, a given extracted contour determined in this step of the process 200 can be expressed as an ordered list of n points c₁, c₂, . . . , cₙ. Each of the points includes both an x coordinate and a y coordinate, so the extracted contour can be represented as a vector of coordinates ((c₁ₓ, c_{1y}), (c₂ₓ, c_{2y}), . . . , (cₙₓ, c_{ny})).

The contour extraction may be implemented at least in part utilizing known techniques such as S. Suzuki and K. Abe, “Topological Structural Analysis of Digitized Binary Images by Border Following,” CVGIP 30 1, pp. 32-46 (1985), and C. H. The and R. T. Chin, “On the Detection of Dominant Points on Digital Curve,” PAMI 11 8, pp. 859-872 (1989). Also, algorithms such as the Ramer-Douglas-Peucker (RDP) algorithm can be applied in extracting the contour from the hand ROI.

The particular number of points included in the contour can vary for different types of hand ROI masks and associated static poses. Contour simplification not only conserves computational and storage resources as indicated above, but can also provide enhanced recognition performance. Accordingly, in some embodiments, the number of points in the contour is kept as low as possible while maintaining a shape close to the actual hand ROI.

Step 4. Left/Right Hand Normalization

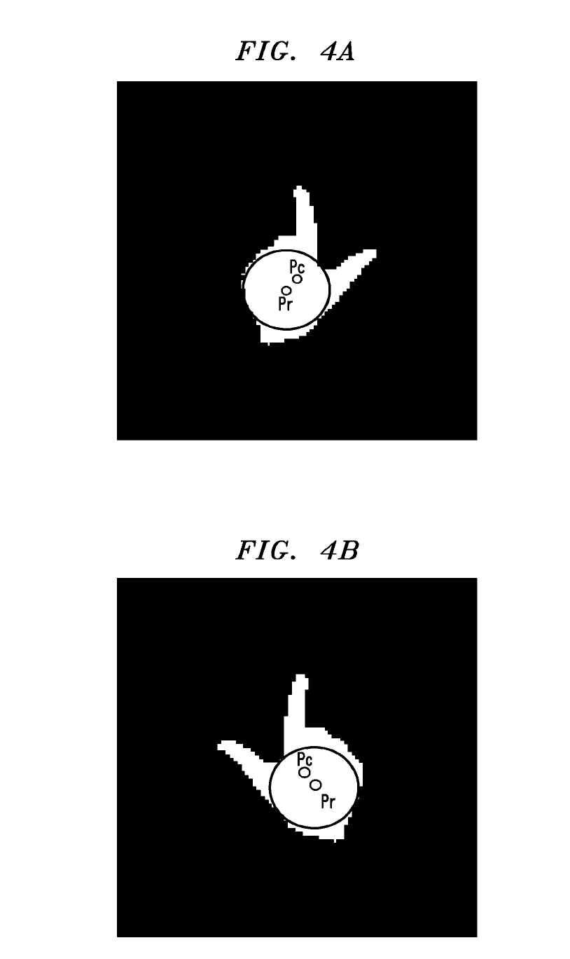

In this step, a given extracted contour is normalized to a predetermined left or right hand configuration. This normalization may involve, for example, flipping the contour points horizontally, as illustrated for corresponding hand ROIs in FIGS. 4A and 4B. More particularly, FIGS. 4A and 4B show respective left hand and right hand versions of a given hand ROI from which a contour has been extracted. It is apparent that the left hand version in FIG. 4A can be obtained by horizontally flipping the right hand version in FIG. 4B, and vice-versa.

The static pose recognition module 114 in the present embodiment is assumed to be configured to operate on either right hand versions or left hand versions. For example, if it is determined in this step that a given extracted contour or its associated hand ROI is a left hand ROI when the static pose recognition module 114 is configured to process right hand ROIs, then the normalization involves horizontally flipping the points of the extracted contour, such that all of the extracted contours subject to further processing correspond to right hand ROIs. For subsequent description below, it is assumed that the static pose recognition module 114 operates using the right hand versions only, and that any detected left hand versions are converted to right hand versions prior to further processing. This is not a requirement, however, and it is possible in some embodiments to process both left hand and right hand versions, for example, using respective distinct sub-classes of a static pose class.

The normalization in Step 4 can alternatively be performed prior to the contour extraction step, utilizing the hand ROI itself rather than the contour points, although the normalization process is generally much more efficient when applied to the extracted contour than to the corresponding hand ROI. For example, as will be described in more detail below, the horizontal flipping of the contour points can be achieved by reversing the order of the ordered list of contour points.

The left hand and right hand versions can be distinguished from one another using a number of different techniques. By way of example, assume with reference to FIGS. 4A and 4B that two points are estimated from the extracted contour for each of the left and right hand versions. The first point may be viewed as the center of mass of the entire hand, denoted as Pc=(Pcₓ, Pc_{y}). If the contour is given by an ordered list of n points c₁, c₂, . . . , cₙ, Pc can be computed as the mean of those points by computing P_{c}=1/nΣᵢ₌₁ⁿcᵢ. The second point may be viewed as the center of mass of the palm only, excluding the wrist and fingers, and is denoted as Pr=(Prₓ, Pr_{y}). In the context of FIGS. 4A and 4B, Pr is more particularly determined as the center of the maximal-circumference circle that can be inscribed within the extracted contour.

Alternatively, the point Pr can be approximately determined using the following computationally-efficient iterative process:

1. Compute an initial center point, such as the center of mass Pc, for example.

2. Compute distances between the points of the contour and the current center point.

3. Compute local minimums of those distances.

4. Compute a new center point as the center of mass of the local minimums or as the center of a circle inscribed in a polygon determined by the local minimums and the two contour points c₁ and cₙ.

5. If the new center point is sufficiently close to the previous center point, or if a designated number of iterations (e.g., 2 iterations) is reached, the process is complete, and otherwise the process returns to step 2. Other convergence properties can be used to terminate the iterative process.

The above iterative process generates a point that is close to the center of the maximal-circumference inscribed circle, but involves significantly less computational complexity than determining the actual center. Such an approximate point is considered an example of what is more generally referred to herein as a center of a maximal-circumference circle that can be inscribed within an extracted contour.

Given the two points Pc and Pr determined in the manner described above, if Pcₓ≦Prₓ, then the current version is assumed to be a right hand version and no normalization is required. However, if Pcₓ>Prₓ, then the current version is assumed to be a left hand version, and the contour points should be flipped horizontally in order to generate the corresponding right hand version for use in subsequent processing. More particularly, the horizontal flipping of the contour points is achieved in the present embodiment by reversing the order of the contour points such that the normalized contour is given by cₙ, cₙ₋₁, . . . , c₁.

In other embodiments, the left hand and right hand versions can be distinguished using both x and y coordinates of the Pc and Pr points.

Additionally or alternatively, information such as a main direction of the hand can be determined and utilized to facilitate distinguishing left hand and right hand versions of the extracted contours. Exemplary techniques for determining hand main direction are disclosed in Russian Patent Application Attorney Docket No. L13-0959RU1, filed Oct. 30, 2013 and entitled “Image Processor Comprising Gesture Recognition System with Computationally-Efficient Static Hand Pose Recognition,” which is commonly assigned herewith and incorporated by reference herein. This particular patent application further discloses additional relevant techniques, such as skeletonization operations for determining a hand skeleton in a hand image, that may be applied in conjunction with distinguishing left hand and right hand versions of an extracted contour in a given embodiment. For example, a skeletonization operation may be performed on a hand ROI, and a main direction of the hand ROI determined utilizing a result of the skeletonization operation.

Other information that may be taken into account in distinguishing left hand and right hand versions of an extracted contour includes, for example, a mean x coordinate of points of intersection of the hand ROI and a bottom row or other designated row of the frame, with the mean x coordinate being determined prior to removing from the hand ROI any pixels below the palm boundary in Step 2 described above.

It is also possible to train a classification engine of the static pose recognition module 114 to recognize left hand and right hand versions of particular hand gestures. This may involve use of a database of training images in which the training images are predetermined as left hand or right hand versions.

Step 5. Feature Vector Computation

In the present embodiment, features are computed from the extracted contour in this step and utilized in subsequent steps to facilitate recognition of static hand poses. It is to be appreciated that other embodiments can be configured to operate directly on the extracted contours. For example, the recognition by dynamic warping in Step 7 of process 200 can be applied directly to the vector of coordinates ((c₁ₓ, c_{1y}), (c₂ₓ, c_{2y}), . . . , (cₙₓ, c_{ny})), such that Steps 5 and 6 are eliminated. However, it is generally much more efficient to perform recognition using feature vectors that are computed based at least in part on the corresponding extracted contours rather than using the extracted contours themselves. The feature vectors may be viewed as parameterizations of the corresponding contours.

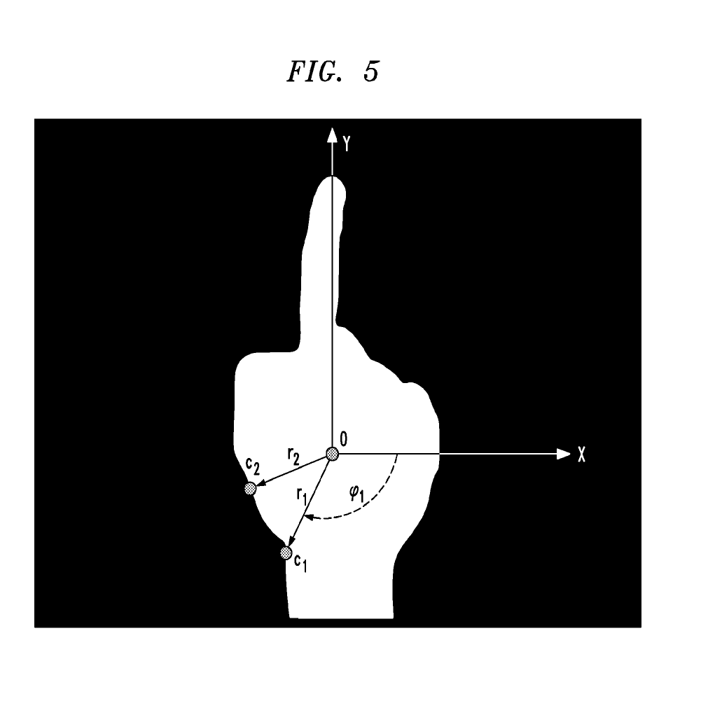

An exemplary feature vector computation will now be described with reference to FIG. 5. This figure shows a pointing figure gesture of the type previously described in conjunction with FIG. 3. A pair of x and y coordinate axes is shown having an origin O. The origin O may correspond to a center point of the extracted contour, such as one of the points Pc or Pr described above, or another point with similar characteristics.

The contour points c₁ and c₂ in FIG. 5 represent two consecutive points from an extracted contour c₁, c₂, . . . , cₙ. Arrowed solid lines emanating from origin O of the coordinate system in the figure are more particularly referred to herein as radius vectors r₁ and r₂ and denote respective distances between contour points c₁ and c₂ and the origin O. The feature vector in such an arrangement illustratively comprises an ordered list of radius vectors r₁, r₂, . . . , rₙ corresponding to respective ones of the contour points c₁, c₂, . . . , cₙ.

As another example, the feature vector computed in Step 5 can further include, for each of the radius vectors, the angle in a clockwise direction between the positive x axis and that radius vector. This angle for radius vector r₁ is illustrated by the dashed line in FIG. 5, and is denoted as φ₁. The feature vector in this example comprises an ordered list of pairs (radius vector, angle), and is more particularly given by ((r₁, φ₁), (r₂, φ₂), . . . , (rₙ, φₙ)), where φₖ is the angle in the clockwise direction between the positive x axis and rₖ.

As yet another example, instead of using absolute angles φ as in the previous example, the feature vector can utilize relative angles ψ. For the first point in the contour ψ₁=0, and for all the other points in the contour ψₖ=φₖ−ψₖ₋₁, where k=2 . . . n. The feature vector in this example comprises an ordered list of pairs (radius vector, relative angle), and is more particularly given by ((r₁, ψ₁), (r₂, ψ₂), . . . , (rₙ, ψₙ)).

Of the three examples above, the feature vector ((r₁, φ₁), (r₂, φ₂), . . . , (rₙ, φₙ)) tends to provide better recognition results than the other two in some embodiments of the exemplary process 200.

However, the foregoing are merely illustrative examples of feature vectors that are computed from an extracted contour in Step 5 of the process 200. A wide variety of other types of features vectors comprising respective different parameterizations of an extracted contour can be used in other embodiments. The term “feature vector” as used herein is therefore intended to be broadly construed, and should not be viewed as being limited in any way to any particular aspects of the above examples.

Prior to computing the feature vector for a given extracted contour in the manner described above, the number and spacing of the contour points may be adjusted in order to improve the regularity of the point distribution over the contour. Such adjustment is useful in that different types of contour extraction can produce different and potentially irregular point distributions, which can adversely impact recognition quality. This is particularly true for embodiments in which the contour is simplified after or in conjunction with extraction. In some embodiments, it has been found that recognition quality generally increases with increasing regularity in the distribution of the contour points.

In order to improve the regularity of the point distribution over the contour, an initial extracted contour comprising the ordered list of points c₁, . . . , cₙ is converted into a processed list of points cc₁, . . . , ccₘ, where distances ∥ccᵢ−ccᵢ₊₁∥ are approximately equal for all i=1 . . . m−1, where m may, but need not, be equal to n. Thus, in some embodiments, the number of points in the contour is changed in this conversion process.

An exemplary technique for converting an initial extracted contour to a contour with improved regularity of point distribution is as follows:

1. Find distances for all i=2 . . . n between consecutive points dᵢ={square root over ((cᵢₓ−c₍ᵢ₋₁₎ₓ)²+(c_{iy}−c_{(i-1)y})²)}, d₁=0.

2. Find cumulative sum D, such that D(i)=Σⱼ₌₁ⁱdⱼ.

3. Divide segment [0,D(n)] into sub-segments having equal length.

In some embodiments, a predetermined number m−1 of equal sub-segments is desired. For such embodiments, nearest neighbor search or other similar approaches can be used to divide segment [0,D(n)] into m−1 equal sub-segments such that sub-segment j, j=1 . . . m−1, contains points ccⱼ and ccⱼ₊₁ which are the nearest points of the contour which give values of D approximately equal to D(n)*(j−1)/(m−1) and D(n)*j/(m−1), respectively.

In other embodiments, a particular sub-segment length is desired, rather than a particular number of sub-segments. Assuming that the desired length is denoted len, then there will be approximately m−1=D(n)/len segments, such that sub-segment j, j=1 . . . m−1, contains points ccⱼ and ccⱼ₊₁ which are the nearest points of the contour which give values of D approximately equal to len*(j−1) and len*j, respectively.

The determination of points ccⱼ and ccⱼ₊₁ as the nearest points of the contour in the foregoing can utilize not only the points from the initial contour c₁, . . . , cₙ, but also interpolated points. This is possible, for example, in the case of simplified contours, because the simplified contour values D(n)*(j−1)/(m−1) and D(n)*j/(m−1) will typically lie sufficiently far from the points of the initial contour. The interpolated points can be determined using linear interpolation, spline interpolation or other types of interpolation.

An exemplary pseudocode implementation of the above-described technique for improving regularity of point distribution is as follows:

d(1) = 0;
for i=2:n

d(i) = sqrt((x(i−1)−x(i)) \hat{ }2 + (y(i−1)−y(i))\hat{ }2);

end
for i=1:n

phi(i) = atan2(y(i)−my, x(i)−mx); % (mx, my) − the center

of the hand

end
D = cumsum(d);
step = len; % or step = D(end)/(m−1);
dd = 0:step:D(end);
r = interpl(D, r, dd, ‘linear’, ‘extrap’);
phi = interpl(D, phi, dd, ‘linear’,‘extrap’);

This pseudocode more particularly illustrates dividing a segment [0,D(n)] of cumulative sum D into equal sub-segments using interpolation.

Step 6. Feature Vector Normalization

In this step, the feature vector computed in Step 5 is normalized. Assuming by way of example that the feature vector is given by ((r₁, φ₁), (r₂, φ₂), . . . , (rₘ, φₘ)), the feature vector can be normalized in the following manner:

1. Divide each of the radial vectors r₁, . . . , rₘ by the corresponding mean radial distance:

$${r}_{k} = {r}_{k} / ( \frac{1}{m} {\sum }_{i = 1}^{m} {r}_{i} ) ,$$

k=1 . . . m.

2. Subtract from each angle φ₁, . . . , φₘ the corresponding mean angle:

$${ϕ}_{k} = {ϕ}_{k} - ( \frac{1}{m} {\sum }_{i = 1}^{m} {ϕ}_{i} ) ,$$

k=1 . . . m.

3. Multiply each of the radial vectors r₁, . . . , rₘ by a weighting factor of f_dist (e.g., f_dist=0.55).

4. Multiply each of the angles φ₁, . . . , φₘ by a weighting factor of f_angle (e.g., f_angle=0.45).

It should be noted that steps 1 and 2 of this exemplary feature vector normalization process may be interpreted as division in the complex number space.

The particular normalization applied in Step 6 will generally vary depending upon the type of feature vector and other factors.

Step 7. Recognition by Dynamic Warping

In this step, dynamic warping of contours is utilized to facilitate recognition of corresponding static poses. The dynamic warping applied in this step will be described in greater detail below.

It is initially assumed by way of illustrative example that recognition involves comparing two time-series signals each of which comprises a contour in the form of an ordered list of points. The two signals are denoted s₁=(p₁, . . . , pₙ₁) and s₁=(q₁, . . . , qₙ₂), where the lengths of the signals are usually different, i.e., n1≠n2. Further assume that there is a similarity measure between the elements of these signals, i.e., for all i=1 . . . n1, j=1 . . . n2, there is a similarity measure function f(pᵢ, qⱼ)≧0. For example, if pᵢ and qⱼ are vectors in k-dimensional Euclidian space, then f(pᵢ, qⱼ) could be the norm of the difference: f(pᵢ, qⱼ)=∥pᵢ−qⱼ∥.

The dynamic warping then more particularly involves finding pairs of lists of integer indexes of the same length N, where N≧max(n1, n2), namely i₁, i₂, . . . , i_{N} and j₁, j₂, . . . , j_{N}, such that for all t=2 . . . N, 0≦iₜ−iₜ₋₁≦1, i₁=1, i_{N}=n1, 0≦jₜ−jₜ₋₁≦1, j₁=1, j_{N}=n2, where the sum Σₜ₌₁^{N}f(pᵢ_{ₜ}, qᵢ_{ₜ})→min denotes the minimal sum over all such “allowed” lists of indexes. This minimal sum is utilized as the above-noted similarity measure between the two signals s₁ and s₂, and is denoted F(s₁, s₂). The process of finding pairs of allowed lists of indexes can be implemented using dynamic programming, and can be efficiently computed with complexity O(n1*n2) using a Viterbi-type algorithm.

In the present embodiment, the dynamic warping is further configured as follows. First, the indexes iₜ and jₜ, after stretching to one range (e.g., 1 . . . n2), for all t=1 . . . N, are permitted to differ by no more than a predetermined value th1<n2, i.e., for all t=1 . . . N, |iₜ*n2/n1−jₜ≦th1. In addition, segments iₜ₁ . . . , iₜ₂ and jₜ₁, . . . , jₜ₂ are prevented from having length t2−t1≧th2, such that if iₜ₁=iₜ₁₊₁= . . . =iₜ₂, jₜ₂−jₜ₁=t2−t1, or alternatively if jₜ₁=jₜ₁₊₁= . . . =jₜ₂, iₜ₂−iₜ₁=t2−t1, which generally ensures that the dynamic warping process cannot move through one signal without moving at all through the other. Exemplary values for the thresholds are th1=9 and th2 =4, although other values may be used.

It is further assumed for the present recognition step that there are e=1 . . . ncl classes of static hand poses to be recognized, and that for each such class a training database of the recognition subsystem 108 comprises a corresponding trained pattern of the form patₑ=(patₑ₁, . . . , patₑₗₑₙ_{_{—}}ₑ)=((meanₑₗ, stdₑₗ), . . . , (meanₑₗₑₙ_{_{—}}ₑ, stdₑₗₑₙ_{_{—}}ₑ)), where len_e denotes the length of the e-th pattern, meanₑⱼ denotes the mean for the j-th element of the e-th pattern, and stdₑⱼ denotes the corresponding standard deviation. An exemplary training process utilized to obtain such patterns for all classes will be described in detail below.

The recognition based on dynamic warping will now be further described in more detail under an assumption that the contour feature vector is given by ((r₁, φ₁), (r₂, φ₂), . . . , (rₘ, φₘ)), although as indicated previously, numerous other types of feature vectors may be used. In this case, the mean and standard deviation for each of the trained patterns are more particularly given by meanₑⱼ=(meanrₑⱼ, meanφₑⱼ) and stdₑⱼ=(stdrₑⱼ, stdφₑⱼ), where meanrₑⱼ is the mean for the radius vector at position j, stdrₑⱼ is the standard deviation for the radius vector at position j, meanφₑⱼ is the mean for the angle at position j, and stdφₑⱼ is the standard deviation for the angle at position j, and where j=1 . . . len_e.

The recognition process under the above feature vector assumption more particularly involves finding the distance between a feature vector s=(s₁, . . . , sₘ)=((r₁, φ₁), . . . , (rₘ, φₘ)) for a contour of length m, and the pattern patₑ, using dynamic warping of the type previously described.

By way of example, the distance between the i-th element of s and j-th element of a given pattern can be determined as follows using a Mahalanobis distance metric:

$$f ( {s}_{i} , {pat}_{ej} ) = \sqrt{\frac{1}{{stdr}_{ej}^{2}} {( {r}_{i} - mean {r}_{ej} )}^{2} + \frac{1}{std {ϕ}_{ej}^{2}} {( {ϕ}_{i} - mean {ϕ}_{ej} )}^{2}} .$$

Other types of distance metrics can also be used. The previously-described dynamic warping is then applied to determine the distance between s and patₑ as F(s, patₑ). This distance may be subject to a final correction taking into account the lengths of both s and patₑ by dividing F(s, patₑ) by the sqrt(m²+len_e²).

Accordingly, for a given contour feature vector s, the recognition process in Step 7 determines the distance between that contour and all of the class patterns, i.e., computes F(s, pat₁), . . . , F(s, pat_{ncl}), and generates a recognition result specifying the particular class to which s belongs as the index of minimum distance in that list of distances, i.e., classₛ=argmin_{e,e=1 . . . ncl}F(s, patₑ).

Examples of static pose classes that may be recognized in a given embodiment include pointing finger, palm with fingers, hand edge, pinch, fist, fingergun and many others.

It is to be appreciated that the particular types of feature vectors, similarity measures, dynamic warping techniques and other aspects of the recognition process of Step 7 are exemplary only and may be varied in other embodiments. For example, a wide variety of other types of dynamic warping operations can be applied, as will be appreciated by those skilled in the art. The term “dynamic warping operation” as used herein is therefore intended to be broadly construed, and should not be viewed as limited in any way to particular features of the exemplary operations described above.

Additional Steps for Training

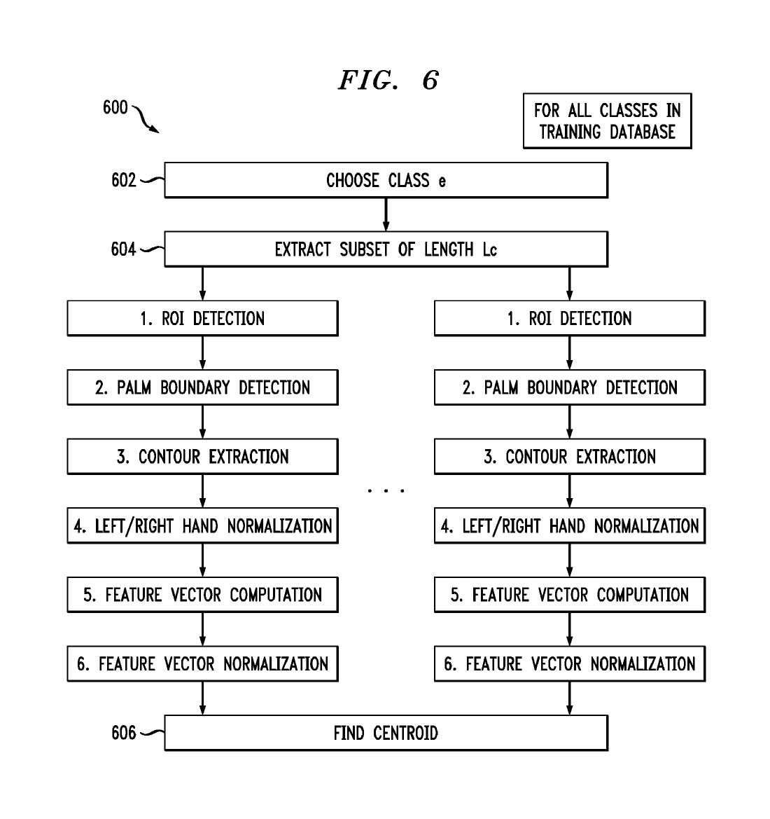

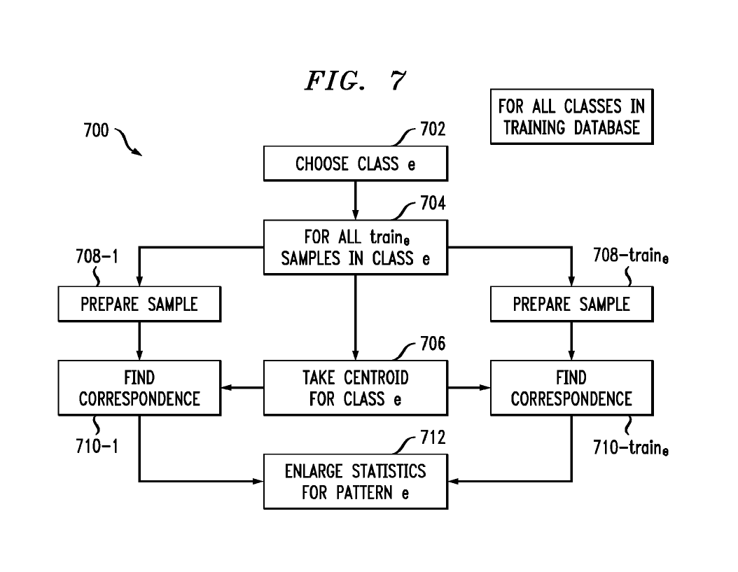

Although not explicitly illustrated in FIG. 2, one or more additional training steps are assumed to be incorporated into the process 200 so as to provide the above-noted patterns for the recognition step. Such training is assumed to involve use of a training database incorporated into or otherwise accessible to the static pose recognition module 114, and will be described in more detail below in conjunction with the flow diagrams of FIGS. 6 and 7. The training database illustratively incorporates training images that include respective known static hand poses and may be implemented at least in part using one or more storage devices associated with the memory 122 of the image processor 102.

Assume by way of example that the training database comprises ncl classes of static hand poses to be recognized by the static pose recognition module 114, and that in each class e=1 . . . ncl there are ncₑ sample images used for training. The training process can be implemented as follows.

Initially, a centroid is determined for each class. This centroid may be determined, for example, by computing argmin(max(F(sᵢ, sⱼ) for all i,j) where F(sᵢ, sⱼ) denotes all pairwise dynamic warping distances between sample images within the class.

An alternative simplified approach is to apply process 600 as illustrated in the flow diagram of FIG. 6. The process 600 includes steps 602, 604 and 606, as well as multiple parallel instances of Steps 1 through 6 of the FIG. 2 process.

In step 602, a particular class e is selected.

In step 604, a subset of the ncₑ sample images of class e is extracted from the training database, for example, by random selection. It is assumed in this embodiment that ncₑ is much larger than Lc, such that min(ncₑ, Lc)=Lc. An exemplary value for Lc may be Lc=50, although other values can be used.

The Lc sample images sₑₗ, S_{eLc} of the extracted subset are utilized to estimate the centroid. The multiple parallel instances of Steps 1 through 6 of the FIG. 2 process are applied to respective ones of the Lc sample images, and so there are Lc parallel instances in the process 600. Each instance generates a normalized feature vector in the manner previously described in conjunction with FIG. 2.

In step 606, the normalized feature vectors received from the respective instances of Steps 1 through 6 of the FIG. 2 process are further processed in the manner described below to determine the centroid for the class e.

This illustratively involves determining Lc*(Lc−1)/2 pairwise distances F(sᵢ, sⱼ), i=1 . . . Lc, j=1 . . . Lc. It should be noted that Lc² pairwise distances are not required, due to the commutative property of metric F(.,.) as well as the fact that F(a, a)=0 for all signal a. It is assumed that the metric f(s₁ᵢ, s₂ⱼ) utilized for elements s₁ᵢ, and s₂ⱼ of vectors S₁=(ss₁₁, . . . , ss₁ₙ₁) and s₂=(ss₂₁, . . . , ss₂ₙ₂) is the norm in Euclidian space: f(ss₁ᵢ, ss₂ⱼ)=∥ss₁ᵢ−ss₂ⱼ∥. Under the further assumption that the contours are in the form of lists of pairs (r, φ), f(ss₁ᵢ, ss₂ⱼ)=\sqrt{(r₁ᵢ−r₂ⱼ)²+(φ₁ᵢ−φ₂ⱼ)²}. Therefore, unlike the recognition process in Step 7 of FIG. 2, the centroid determination in step 600 of the training process does not utilize means and standard deviations. However, dynamic warping is applied in the manner previously described in conjunction with Step 7 in order to obtain F(sᵢ, sⱼ), i=1 . . . Lc, j=1 . . . Lc. The centroid cntrₑ for class e is then determined as cntrₑ=min_{i=1 . . . Lc}max_{j=1 . . . Lc}(F(sₑᵢ, sₑⱼ)).

The process 600 is repeated for each of the classes in the training database, with a different class e being selected on each iteration.

In other embodiments, it may be desirable to determine two or more centroids for each of one or more of the classes, with each such centroid for a given class corresponding to a primary dissimilar hand pose variation within that class. For example, if the training images within a class have not all been normalized to either left hand or right hand versions of the corresponding static hand pose, separate centroids may be determined for the left hand and right hand versions. Other dissimilar hand pose variations may be treated in a similar manner.

Moreover, each class for which multiple centroids are determined can be separated into multiple sub-classes each corresponding to one of the multiple centroids. The recognition in Step 7 can then be configured to generate a recognition result that indicates not only the class but also the sub-class for a given input image. The separation of classes into sub-classes can be implemented, for example, using clustering techniques, such as the k-means algorithm.

After the centroids are determined for each class in the manner described above, the patterns for each class are obtained using the process 700 of FIG. 7.

In step 702, a particular class e is selected.

In step 704, all of the sample images in class e are obtained.

In step 706, the centroid for class e is obtained, as previously determined in process 600 of FIG. 6.

There are multiple parallel processing paths for respective ones of the sample images of class e in the process 700. Each such processing path includes an instance of step 708 followed by an instance of step 710. The figure shows only the first and final parallel processing paths, although it is assumed that there are trainₑ such parallel processing paths, one for each of the sample images to be used for pattern training in class e, where trainₑ≦ncₑ. The first of these multiple parallel processing paths includes steps 708-1 and 710-1, and the final one includes steps 708-trainₑ and 710-trainₑ. The trainₑ samples associated with class e are more specifically denoted as samples sₑₗ, . . . , sₑₜᵣₐᵢₙₑ.

In each of the parallel processing paths of the process 700, step 708 prepares the corresponding sample using Steps 1 through 6 of FIG. 2 to generate a normalized feature vector from that sample. Step 710 then determines the correspondence between that normalized feature vector and the previously-determined centroid for class e.

More particularly, for each i=1 . . . trainₑ, distance F(sₑᵢ, cntrₑ) is obtained using a technique similar to that used to determine the centroid in FIG. 6, and correspondence between elements sₑᵢ and cntrₑ which leads to this distance is determined. For simplicity, in the following sₑᵢ is denoted as z and cntrₑ is denoted as x. Using dynamic warping as described previously, two lists of indexes u₁, . . . , u_{N} and v₁, . . . , v_{N} are determined for z and x, respectively, where z=(z₁, . . . , zₙ) and x=(x₁, . . . , xₘ), and element zᵤₜ corresponds to xᵥₜ for all t=1 . . . N.

Also, for all p=1 . . . m there exist two numbers 1≦tp1≦tp2≦N, such that vₜₚ₁=Vtp₁₊₁= . . . =Vₜₚ₂=p. So for each element of x, a set of elements zᵤₜₚ₁, . . . , zᵤₜₚ₂ can be found that correspond to the element xₚ.

In step 712, the correspondences determined in steps 710-1 through 710-trainₑ are processed to enlarge the available statistics for pattern e. More particularly, statistics are enlarged for each p=1 . . . m: statₑ(p)=[statₑ(p)_zᵤₜₚ₁, . . . , zᵤₜₚ₂] where initially statₑ(p)=[ ] for all p. It should be noted that m=len_e in this embodiment, where len_e denotes the length of the centroid and thus the corresponding pattern e. After computing statₑ for all sₑᵢ, i=1 . . . trainₑ, the pattern for class e is obtained as meanₑₚ=mean(statₑ(p)) and stdₑₚ=std(statₑ(p)), for all p=1 . . . len_e, where mean(.) and std(.) are the corresponding statistical operators.

Like the process 600, the process 700 is repeated for each of the classes in the training database, with a different class e being selected on each iteration.

The particular types and arrangements of processing blocks shown in the embodiments of FIGS. 2, 6 and 7 are exemplary only, and additional or alternative blocks can be used in other embodiments. For example, blocks illustratively shown as being executed serially in the figures can be performed at least in part in parallel with one or more other blocks or in other pipelined configurations in other embodiments.

The illustrative embodiments provide significantly improved gesture recognition performance relative to conventional arrangements. For example, these embodiments provide significant enhancement in the computational efficiency of static pose recognition through the use of dynamic warping of contour feature vectors. Accordingly, the GR system performance is accelerated while ensuring high precision in the recognition process. The disclosed techniques can be applied to a wide range of different GR systems, using depth, grayscale, color infrared and other types of imagers which support a variable frame rate, as well as imagers which do not support a variable frame rate.

Different portions of the GR system 110 can be implemented in software, hardware, firmware or various combinations thereof. For example, software utilizing hardware accelerators may be used for some processing blocks while other blocks are implemented using combinations of hardware and firmware.

At least portions of the GR-based output 112 of GR system 110 may be further processed in the image processor 102, or supplied to another processing device 106 or image destination, as mentioned previously.

It should again be emphasized that the embodiments of the invention as described herein are intended to be illustrative only. For example, other embodiments of the invention can be implemented utilizing a wide variety of different types and arrangements of image processing circuitry, modules, processing blocks and associated operations than those utilized in the particular embodiments described herein. In addition, the particular assumptions made herein in the context of describing certain embodiments need not apply in other embodiments. These and numerous other alternative embodiments within the scope of the following claims will be readily apparent to those skilled in the art.

What is claimed is:

1. A method comprising steps of:
identifying a hand region of interest in at least one image;
extracting a contour of the hand region of interest;
computing a feature vector based at least in part on the extracted contour; and
recognizing a static pose of the hand region of interest utilizing a dynamic warping operation based at least in part on the feature vector;
wherein the steps are implemented in an image processor comprising a processor coupled to a memory.

2. The method of claim 1 wherein the steps are implemented in a static pose recognition module of a gesture recognition system of the image processor.

3. The method of claim 1 wherein identifying a hand region of interest comprises generating a hand image comprising a binary region of interest mask in which pixels within the hand region of interest all have a first binary value and pixels outside the hand region of interest all have a second binary value complementary to the first binary value.

4. The method of claim 1 further comprising:
identifying a palm boundary of the hand region of interest; and
modifying the hand region of interest to exclude from the hand region of interest any pixels below the identified palm boundary.

5. The method of claim 1 wherein the extracted contour comprises an ordered list of n points c₁, C₂, . . . , cₙ.

6. The method of claim 5 wherein the feature vector comprises an ordered list of n radius vectors r₁, r₂, . . . , rₙ corresponding to respective ones of the n contour points c₁, c₂, . . . , cₙ.

7. The method of claim 6 wherein the feature vector further comprises an ordered list of pairs (r₁, φ₁), (r₂, φ₂), . . . , (rₙ, φₙ), where φₖ denotes an angle associated with radius vector rₖ.

8. The method of claim 1 further comprising:
determining if the extracted contour corresponds to a particular predetermined one of a left hand version and a right hand version; and
if the extracted contour does not correspond to the particular predetermined one of the left hand version and the right hand version, normalizing the extracted contour to correspond to the particular predetermined one of the left hand version and the right hand version.

9. The method of claim 1 further comprising:
determining a first center point as a center of mass of the extracted contour and a second center point as a center of a maximal-circumference circle that can be inscribed in the extracted contour; and
comparing the first and second center points to determine if the extracted contour corresponds to a left hand version or a right hand version.

10. The method of claim 9 wherein the second center point is determined by applying an iterative process to an initial center point, the iterative process comprising:
computing distances between points of the contour and the initial center point;
computing local minimums of said distances;
computing a new center point based at least in part on the local minimums; and
repeating said computing using the new center point until a designated convergence property is satisfied.

11. The method of claim 5 further comprising adjusting a point distribution of the extracted contour by converting the ordered list of points c₁, . . . , cₙ into a processed list of m points cc₁, . . . , ccₘ, where distances ∥ccᵢ−ccᵢ₊₁∥ are approximately equal for all i=1 . . . m−1, and where m may, but need not, be equal to n.

12. The method of claim 1 wherein the dynamic warping operation comprises:
identifying pairs of allowed lists of integer indexes; and
computing a minimal sum of a similarity measure over the identified pairs of allowed lists of integer indexes.

13. The method of claim 12 wherein the allowed lists of integer indexes in a given one of the pairs are permitted to differ from one another by no more than a specified threshold value.

14. The method of claim 12 wherein the allowed lists of integer indexes in a given one of the pairs are prevented from having a segment length that exceeds a specified threshold value.

15. An article of manufacture comprising a computer-readable storage medium having computer program code embodied therein, wherein the computer program code when executed in the image processor causes the image processor to perform the method of claim 1.

16. An apparatus comprising:
an image processor comprising image processing circuitry and an associated memory;
wherein the image processor is configured to implement a gesture recognition system utilizing the image processing circuitry and the memory, the gesture recognition system comprising a static pose recognition module; and
wherein the static pose recognition module is configured to identify a hand region of interest in at least one image, to extract a contour of the hand region of interest, to compute a feature vector based at least in part on the extracted contour, and to recognize a static pose of the hand region of interest utilizing a dynamic warping operation based at least in part on the feature vector.

17. The apparatus of claim 16 wherein the extracted contour comprises an ordered list of n points c₁, c₂, . . . , cₙ, and the feature vector comprises at least one of:
an ordered list of n radius vectors r₁, r₂, . . . , rₙ corresponding to respective ones of n contour points c₁, c₂, . . . , cₙ; and
an ordered list of pairs (r₁, φ₁), (r₂, φ₂), . . . , (rₙ, φₙ), where φₖ denotes an angle associated with radius vector rₖ.

18. The apparatus of claim 16 wherein the dynamic warping operation comprises:
identifying pairs of allowed lists of integer indexes; and
computing a minimal sum of a similarity measure over the identified pairs of allowed lists of integer indexes.

19. An integrated circuit comprising the apparatus of claim 16.

20. An image processing system comprising the apparatus of claim 16.
